(19) United States
(12) Patent Application Publication
(10) Pub. No.: US 2010/0031514 A1
(43) Pub. Date: Feb. 11, 2010

(54) DRIVE MEMBER EXTRACTOR TOOL FOR ELECTRIC HAIR CUTTING DEVICES

(76) Inventor: Gabriel S. Kohn, Boca Raton, FL (US)

Correspondence Address: Sunbeam Products, Inc., 2381 Executive Center Drive, Boca Raton, FL, 33431, US

(21) Appl. No.: 12/188,464

(22) Filed: Aug. 8, 2008

(51) Int. Cl. B26B 19/02; B26B 19/38

(52) U.S. Cl. 30/216; 30/223

(57) ABSTRACT

A replaceable system for use with a hair cutting device, such as a hair clipper or trimmer, having a rotary electric motor and a bladeset is provided. The replaceable system includes a drive member removably positionable between the rotary electric motor and the bladeset of the hair cutting device. The drive member includes a first end operably engaged to a moveable blade of the bladeset and a second end operably engaged to the rotary electric motor. The drive member translating the rotary motion of the rotary electric motor to a reciprocating linear motion. An extraction tool is further provided, where the extraction tool is removable attachable to the drive member and is usable to remove and insert the drive member between the rotary motor and the bladeset.

### FIELD OF THE INVENTION

The present disclosure relates generally to hair cutting devices, such as clipper and trimmers, having a bladeset including a moving blade reciprocating relative to a stationary blade and a drive system for powering the bladeset, and more specifically, to an extractor tool for the removal and insertion of a drive member interposed between the drive system and the movable blade.

### BACKGROUND OF THE INVENTION

Conventional hair cutting devices, such as hair clippers and trimmers, typically include a drive bearing powered by the drive shaft of the rotary motor. The drive bearing converts the rotary motion generated by the rotary motor into linear motion in the form of the reciprocating movable blade relative to the stationary blade.

Specifically, the drive bearing is offsettingly mounting to the end of the drive shaft. In this manner, the drive bearing member is eccentrically rotated as the drive shaft rotates. A drive member is positioned between, and operably connected to, the drive bearing at one end and engages the movable blade at an opposite ended.

In operation, the eccentric rotation of the drive bearing results in a reciprocating, linear, translation of the one end of the drive member, and an opposite reciprocating, linear, translation of the opposite end of the drive member and the moveable blade. In time, operational conditions, including heat and friction, combine to cause wear and deterioration of the drive member. Such wear decreases operational efficiency of the hair cutting device and often increases operational noise, and would require replacement of the drive member. The replacement of the drive member can be difficult due to the limited space and fit tolerances.

### SUMMARY OF THE INVENTION

The present disclosure provides a replaceable system for use with hair cutting devices, such as clippers and trimmers, having a rotary electric motor and bladeset. The replaceable system includes a drive member removably positionable between the rotary electric motor and the bladeset of the hair cutting device. The drive member translates the rotary motion of the rotary electric motor to a reciprocating linear motion. An extraction tool is further provided, where the extraction tool is removable attachable to the drive member.

The hair cutting device has an electric rotary motor and a bladeset, where the bladeset has a stationary blade and a moveable blade. The drive member is removably interposed between the electric rotary motor and the bladeset, where a first end of the drive member operably engages the rotary motor and a second end of the drive member operably engages the moveable blade of the bladeset. The extraction tool is removably attachable to the center body of the drive member, such that the extraction tool is usable to remove and insert the drive member between the rotary motor and the bladeset.

In a method of replacing the drive member in the hair cutting device, the extraction tool is attached to the drive member. The extraction end of the extraction tool is removably engaged to the center body of the driving member. The extraction tool is used to remove the drive member from between the rotary motor and the blade set.

A second, new, drive member is provided, where the extraction end of the extraction tool removably engages the center body of the second driving member. Using the extraction tool, the second drive member is inserted between the rotary motor and the bladeset, where the first end of the second drive member is operably connected to the rotary motor and the second end of the drive member in operably connected to the moveable blade.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a top isometric view of a hair cutting device for use with the drive member of the present disclosure;

FIG. 2 depicts a sectional top isometric view of the hair cutting device of FIG. 1;

FIG. 3 depicts a sectional top isometric view of the drive system of the hair cutting device of FIG. 1;

FIG. 4 depicts a drive member of the present disclosure;

FIG. 5 depicts an extraction tool of the present disclosure;

FIG. 6 depicts the extraction tool of FIG. 5 in use to engage a drive member of FIG. 4;

FIG. 7 depicts the drive member of FIG. 4 engaging a moveable blade;

FIG. 8 depicts another drive member of the present disclosure;

FIG. 9 depicts a cross sectional view of the drive member of FIG. 8;

FIGS. 10A and 10B depict another drive member and extraction tool configuration in a disengaged and engaged configuration;

FIGS. 11A and 11B depict another drive member and extraction tool configuration in a disengaged and engaged configuration; and

FIGS. 12A and 12B depict another drive member and extraction tool configuration in a disengaged and engaged configuration.

### DETAILED DESCRIPTION OF THE INVENTION

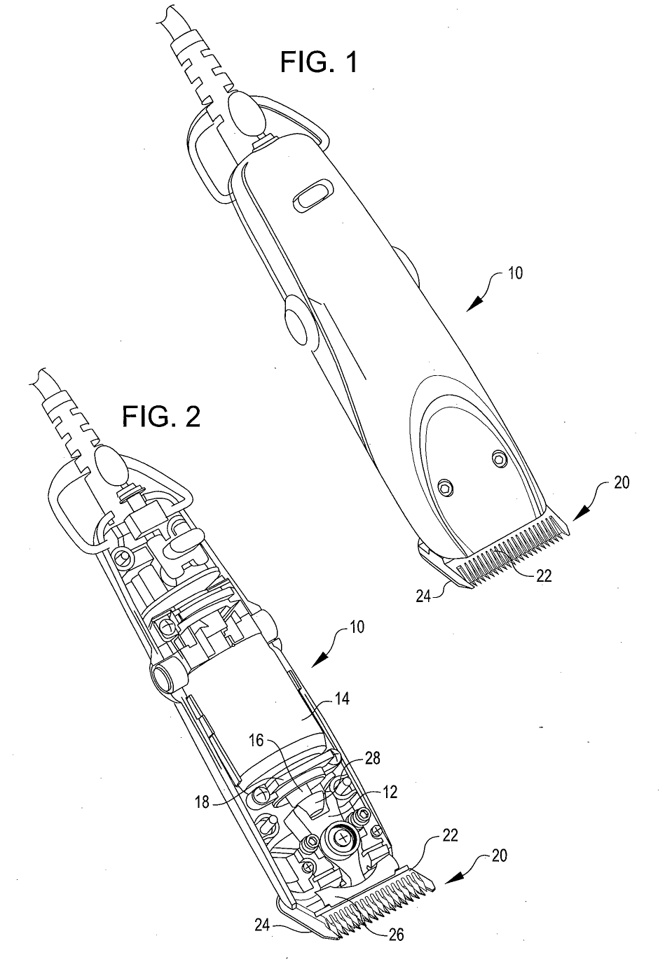

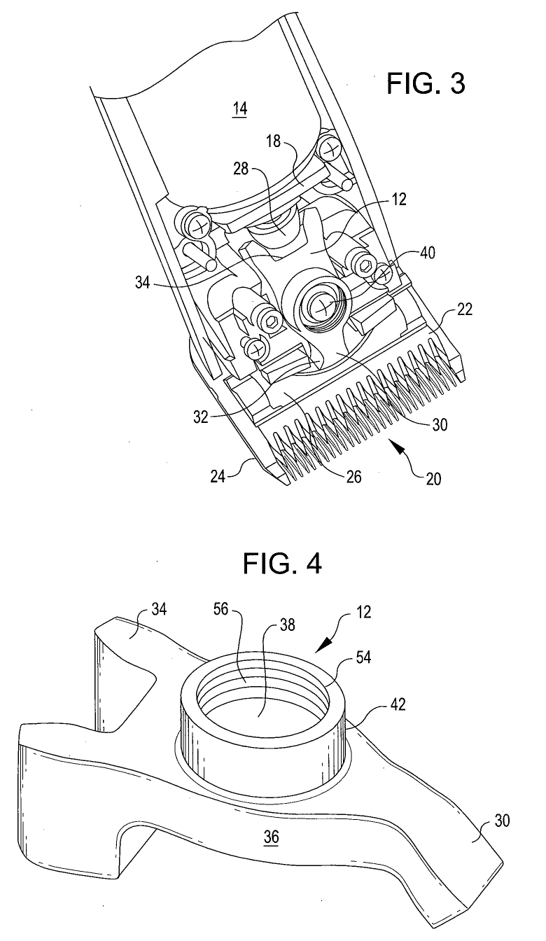

Referring now to the drawing figures in which like reference designators refer to like elements, there is shown in FIGS. 1-3, a hair cutting device 10 suitable for use with the drive member of the present disclosure is provided. The hair cutting device 10 includes a rotary type electric motor 14 having a drive shaft 16 projecting axially from a motor housing 18. A bladeset 20 having movable and stationary blades 22, 24 is operably connected to an end portion of the hair cutting device 10. The bladeset 20 includes a biasing element 26 which causes the moveable blade 22 to be slidingly biased against the stationary blade 24.

In order to translate the rotation of the drive shaft 16 into a linear motion a drive bearing 28 is affixed to the end of a drive shaft 16. The drive bearing 28 is mounted to the drive shaft 16 in an off axis position. In this manner, as the electric motor 14 rotates the drive shaft 16, the drive bearing 28 is eccentrically rotated.

The drive member 12 is positioned between the bladeset 20 and the motor 14. The drive member 12 is pivotally attached to the hair cutting device 10 with the first end 30 of the drive member 12 engaging a drive recess 32 in the movable blade 22 and a second end 34 of the drive member 12 engaging the drive bearing 28.

In operation, an activation of the electric motor 14 rotates the drive bearing 28 in an eccentric rotational motion. The eccentric rotational motion of the drive bearing 28 drives the second and first ends 34, 30 of the drive member 12 in reciprocating linear motions. As the first end 30 of the drive member 12 engages the movable blade 22, the movable blade 22 is likewise moved is a reciprocating linear motion relative to the stationary blade 24.

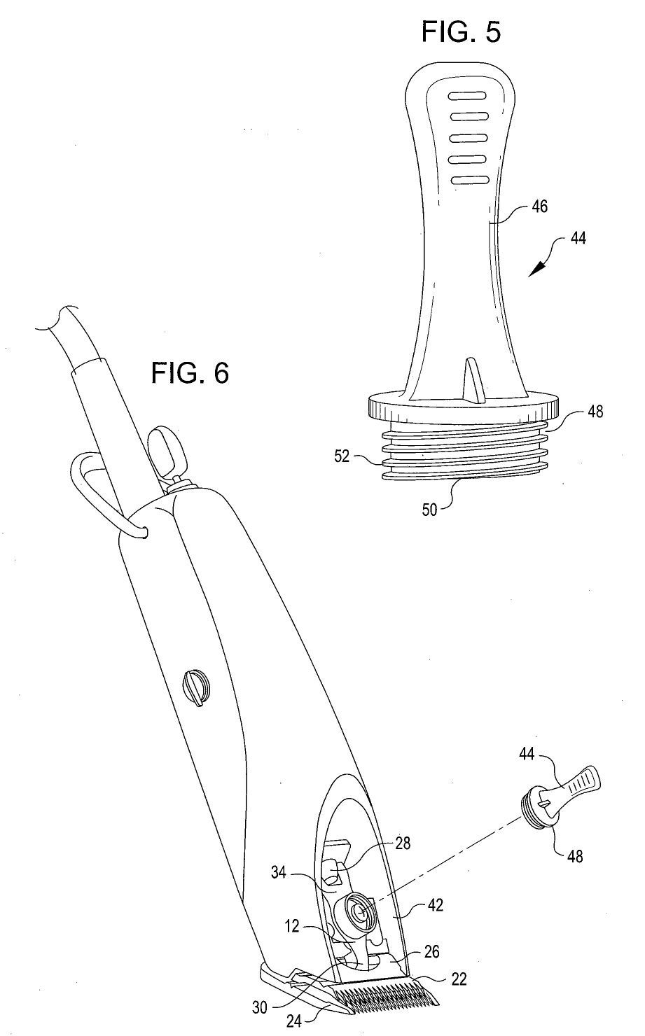

Referring to FIGS. 4 and 5, a drive member 12 of the present invention is provided. The drive member 12 includes a central body portion 36 having a first and second ends 30, 34. A center aperture 38 is provided through the central body portion 36 for receiving a fastener 40 there through. The fastener 40 pivotally connects the drive member 12 to the hair cutting device 10. A raised housing 42 is positioned about the center aperture 38, where the fastener 40 is insertable through the raised housing 42 and center aperture 38 to pivotally connect the drive member 12 to the hair cutting device 10. An extraction tool 44 is also provided having a handle portion 46 and an engagement end 48. The engagement end 48 of the extraction tool 44 is configured to removable connect to the raised housing 42 of the drive member 12.

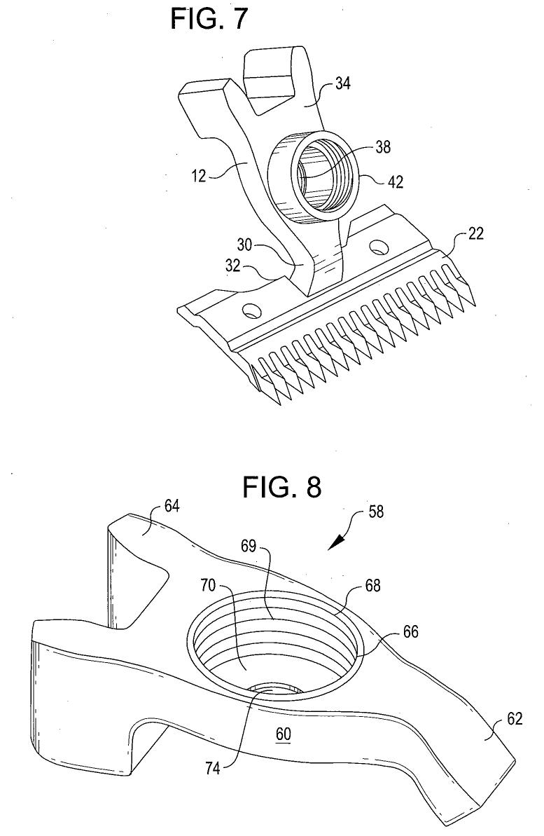

Referring to FIGS. 6 and 7, in operation, the extraction tool 44 can be used to remove and insert a new drive member 12 from the hair cutting device 10. During operation of the hair cutting device 10, the drive member 12 wears over time, requiring replacement. In operation, the worn drive member 12 is removed from the clipper 10 by an initial removal of the fastener 40 positioned through the raised housing 42 and center aperture 38 of the drive member 12. The engagement end 48 of the extraction tool 44 is connected to the raised housing 42 of the drive member 12. Using the extraction tool 44, the drive member 12 is then removed from the hair cutting device 10.

The new drive member 12 can then be inserted. The engagement end 48 of the extraction tool 44 is connected to the raised housing 42 of the new drive member 12. Using the extraction too 44, the new drive member 12 is seated in the hair cutting device 10, such that the first end 30 of the new drive member 12 engages the drive recess 32 in the movable blade 22 and the second end 34 of the new drive member 12 engages the drive bearing 28. Once the new drive member 12 is seated, the extraction tool 44 can be disconnected from the new drive member 12. The fastener 40 is replaced, being positioned through the raised housing 42 and center aperture 38, to pivotally securing the new drive member 12 to the hair cutting device 10.

Referring again to FIGS. 4 and 5, the engagement end 48 of the extraction tool can include raised threads 52 about the outer surface 50 thereof. The inner surface 54 of the raised housing 42 includes raised threads 56 thereon, matching the raised thread 52 of the engagement end 48 of the extraction tool 44. In this manner, the extraction tool 44 can be connected to the drive member 12 by inserting and threading the engagement end 48 of the extraction tool 44 into the raised housing 42.

Alternatively, the engagement end 48 of the extraction tool 44 can include raised threads about an inner surface thereof. The outer surface of the raised housing 42 includes raised threads thereon, matching the raised thread of the engagement end 48 of the extraction tool 44. In this manner, the extraction tool 44 can be connected to the drive member 12 by threading the engagement end 48 of the extraction tool 44 about the raised housing 42.

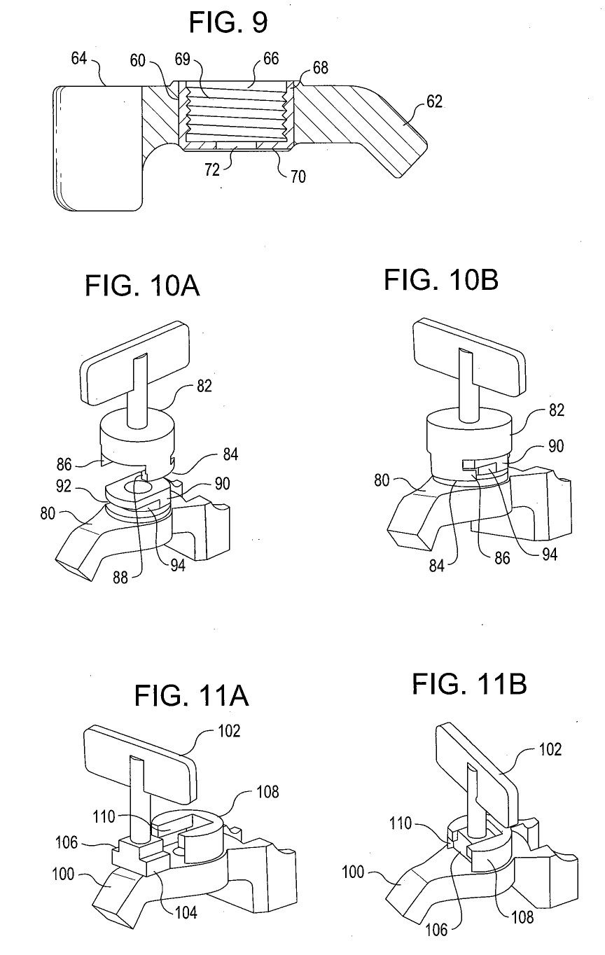

Referring to FIGS. 8 and 9, an alternative drive member 58 of the present invention is provided. The drive member 58 includes a central body portion 60 having a first and second ends 62, 64. A center aperture 66 is provided partially through the central body portion 60, where the inner wall 68 of the center aperture 66 is threaded 69. A bottom wall 70 of the center aperture 66 includes a through hole 72 for receiving a fastener 40 there through. The fastener 40 pivotally connects the drive member 58 to the hair cutting device 10. Referring also to FIG. 5, the engagement end 48 of the extraction tool 44 includes matching raised threads 52. In this manner, the extraction tool 44 can be connected to the drive member 58 by inserting and threading the engagement end 48 of the extraction tool 44 into the center aperture 66 of the central body portion 60.

In the above examples the extraction tool 44 is connected to the drive member 12 or 58 using threaded elements. However, it is contemplated that the extraction tool 44 can be connected to the drive member 12 or 58 using other mechanical interlocking means.

Referring to FIGS. 10A and 10B, a drive member 80 and extraction tool 82 having a mechanical interlock is provided. The engagement end 84 of the extraction tool 82 includes a pair of locking taps 86, 88. The housing 90 on the drive member 80 includes oppositely positioned slotted sections 92, 94 configured to receiving the locking taps 86, 88. The extraction tool 82 is attached to the drive member 80 by positioning the engagement end 84 of the extraction tool 82 about the housing 90 and rotating the engagement tool 82 to seat the locking taps 86, 88 in the slotted sections 92, 94 in the housing 90. The extraction tool 82 can be removed from the drive member 80 by rotating the extraction tool 82 in an opposite direction, unseating the locking taps 86, 88 from the slotted sections 92, 94.

Referring to FIGS. 11A and 11B, another drive member 100 and extraction tool 102 having a mechanical interlock is provided. The engagement end 104 of the extraction tool 102 includes a stepped engagement member 106. The housing 108 on the drive member 100 includes a stepped channel 110, configured for receiving the stepped engagement member 106 of the extraction tool 102 therein. The extraction tool 102 is attached to the drive member 100 by slidingly positioning the stepped engagement member 106 of the extraction tool 102 in the stepped channel 110. The extraction tool 102 can be removed from the drive member 100 by sliding the stepped extraction member 106 out of the stepped channel 100 in the housing 108.

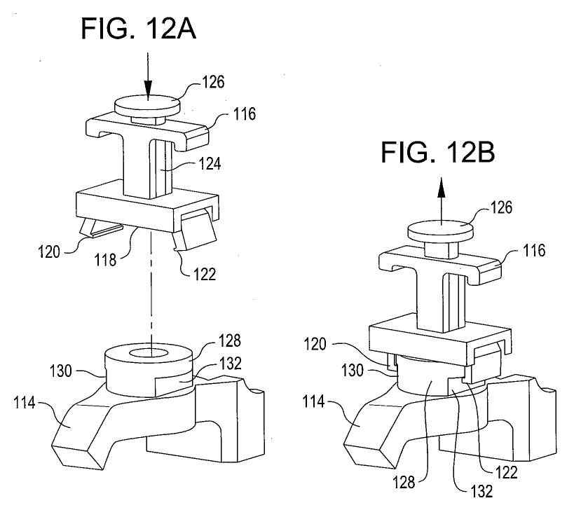

Referring to FIGS. 12A and 12B, another drive member 114 and extraction tool 116 having a mechanical interlock is provided. The engagement end 118 of the extraction tool 116 includes a pair of locking taps 120, 122. The locking taps 120, 122 are pivotally connected to the engagement end 118 and include a bias member 124 disposed there between. The bias member 124 biases the locking taps 120, 122 in a locked position. A release button 126 is operably connected to the bias member 124, where a depression of the release button 126 actuates the bias member 124 to bias the locking taps 120,122 in the open position. Upon releasing the release button 126, the biases member 124 biases the locking taps 120,122 into the locker position.

The housing 128 on the drive member 114 includes oppositely positioned slotted sections 130, 132 configured for receiving the locking taps 120, 122. The extraction tool 116 is attached to the drive member 114 by depressing the release button 126 to open the locking taps 120,122 and positioning the engagement end 118 of the extraction tool 116 about the housing 128. Once positioned, the release button 126 is released, such the bias member 124 to biases the locking taps 120, 122 in a locked position. In the locked position, the lock taps 120, 122 engage the slotted sections 130, 132, locking the extraction tool 116 to the drive member 114. The extraction tool 116 can be removed from the drive member 114 by depressing the release button 126 to open the locking tabs 120,122.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A replaceable system for use with a hair cutting device having a rotary electric motor and bladeset, the replaceable system comprising:
a drive member removably positionable between the rotary electric motor and the bladeset; and
an extraction tool removable attachable to the drive member.

2. A replaceable system for use with a hair cutting device as set forth in claim 1, wherein the drive member includes:
a first end operable engagable with the bladeset;
a second end operably engagable with the rotary electric motor; and
a center body, wherein the extraction tool is removably attachable to the center body.

3. A replaceable system for use with a hair cutting device as set forth in claim 2, wherein the extraction tool includes a handle portion and an engagement end, wherein the engagement end is removable attachable to the center body.

4. A replaceable system for use with a hair cutting device as set forth in claim 3, wherein the engagement end is threaded, the engagement end being threadably attachable to a threaded portion of the center body.

5. A replaceable system for use with a hair cutting device as set forth in claim 3, the center body of the drive member includes a raised housing, wherein the engagement end is removable attachable to the raised housing.

6. A replaceable system for use with a hair cutting device as set forth in claim 5, wherein the engagement end is threadably attachable to a threaded portion of the raised housing.

7. A replaceable system for use with a hair cutting device as set forth in claim 5, wherein the engagement end and center body include a mechanical interlock.

8. A hair cutting device comprising:
an electric rotary motor;
a bladeset including a stationary blade and a moveable blade;
a drive member removably interposed between the electric rotary motor and the bladeset, the drive member including a first end operably engaged to the moveable blade of the blade set, a second end operably engagable to the rotary motor, and a center body; and
an extraction tool removably attachable to the center body of the drive member, the extraction tool being usable to remove and insert the drive member between the rotary motor and the bladeset.

9. A replacement kit for a hair cutting device as set forth in claim 8, wherein the extraction tool includes a handle portion and an engagement end, wherein the engagement end is removable attachable to the center body.

10. A hair cutting device as set forth in claim 9, wherein the engagement end is threaded, the engagement end being threadably attachable to a threaded portion of the center body.

11. A hair cutting device as set forth in claim 9, the center body of the drive member includes a raised housing, wherein the engagement end is removably attachable to the raised housing.

12. A hair cutting device as set forth in claim 11, wherein the engagement end is threadably attachable to a threaded portion of the raised housing.

13. A hair cutting device as set forth in claim 11, wherein the engagement end and center body include a mechanical interlock.

14. A hair cutting device as set forth in claim 8, wherein the drive member converts the rotary drive motion of the electric rotary motors or a reciprocation linear motion in the moveable blade.

15. A method of replacing a drive member in a hair cutting device comprising:
providing a hair cutting device including a rotary motor, a bladeset having a stationary blade and a moveable blade, and a drive member removable interposed between the rotary motor and the bladeset, the drive member including a first end operably engagable to the moveable blade, a second end operably engagable to the rotary motor, and a center body;
providing an extraction tool including a handle portion and extraction end;
attaching the extraction tool to the drive member, wherein the extraction end of the extraction tool removably engages the center body of the driving member;
using the extraction tool to remove the drive member from between the rotary motor and the blade set;
providing a second drive member;
attaching the extraction tool to the second drive member, wherein the extraction end of the extraction tool removably engages the center body of the second driving member; and
using the extraction tool to insert the second drive member between the rotary motor and the bladeset, where the first end of the second drive member is operably connected to the moveable blade and the second end of the drive member in operably connected to the moveable blade.
